(19) United States
(12) Patent Application Publication
(10) Pub. No.: US 2004/0264579 A1
(43) Pub. Date: Dec. 30, 2004

(54) System, method, and apparatus for displaying a plurality of video streams

(76) Inventors: Sandeep Bhatia, Bangalore (IN); Satheesh Babu, Trivandrum (IN); Santosh Savekar, Bangalore (IN)

Correspondence Address: MCANDREWS HELD & MALLOY, LTD, 500 WEST MADISON STREET, SUITE 3400, CHICAGO, IL, 60661

(21) Appl. No.: 10/610,071

(22) Filed: Jun. 30, 2003

(51) Int. Cl. H04N 7/12

(52) U.S. Cl. 375/240.25; 375/240.24

(57) ABSTRACT

Presented herein is a system, method, and apparatus for displaying a plurality of video sequences in real-time while reducing the required buffer memory. In an exemplary embodiment, a decoder system is presented that decodes and presents two video sequences, with three frame buffers per video sequence.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

A useful feature in video presentation is the simultaneous display of multiple video streams. Simultaneous display of multiple video streams involves displaying the different videos streams in selected regions of a common display.

One example of simultaneous display of video data from multiple video streams is known as the picture-in-picture (PIP) feature. The PIP feature displays a primary video sequence on the display. A secondary video sequence is overlayed on the primary video sequence in a significantly smaller area of the screen.

Another example of simultaneous display of video data from multiple video streams includes displaying multiple video streams recording simultaneous events. In this case, each video stream records a separate, but simultaneously occurring event. Presenting each of the video streams simultaneously allows the user to view the timing relationship between the two events.

Another example of simultaneous presentation of multiple video streams includes video streams recording the same event from different vantage points. The foregoing allows the user to view a panorama recording of the event.

One way to present multiple video streams simultaneously is by preparing the frames of the video streams for display as if displayed independently, concatenating the frames, and shrinking the frames to the size of the display. However, the foregoing increases hardware requirements because additional video decoders are required.

In many unified architectures, additional frame buffers are required for decoding video sequences that include temporally coded frames. The additional frame buffers increase the cost of the decoder system.

Further limitations and disadvantages of conventional and traditional systems will become apparent to one of skill in the art through comparison of such systems with the invention as set forth in the remainder of the present application with reference to the drawings.

### BRIEF SUMMARY OF THE INVENTION

In one embodiment, there is described a way to decode a plurality of frames by decoding a first portion of a first frame, then decoding a first portion of a second frame, and then decoding a second portion of the first frame.

In another embodiment, there is described a circuit for displaying a plurality of frames. The circuit includes a decoder for decoding a first portion of a first frame, then a first portion of a second frame, and then decoding the second portion of the first frame. The circuit also includes one frame buffer for storing the portions of the first frame, and another frame buffer for storing the portions of the second frame.

In another embodiment, there is illustrated a block diagram of an exemplary circuit for displaying a plurality of frames. The circuit includes a decoder and a memory. The memory stores instructions that are executed by the decoder. The instructions include decoding a first portion of a first frame, then decoding a first portion of a second frame, and then decoding a second portion of the first frame.

These and other advantages and novel features of the present invention as well as illustrated embodiments thereof will be more fully understood from the following description and drawings.

### BRIEF DESCRIPTION OF SEVERAL VIEWS OF THE DRAWINGS

FIG. 1 is a block diagram of a decoder system in accordance with an embodiment of the present invention;

FIG. 2 is a block diagram describing the decode and display of frames in accordance with an embodiment of the present invention;

FIG. 3 is a flow chart for decoding frames in accordance with an embodiment of the present invention;

FIG. 4 is a block diagram describing an exemplary video sequence;

FIG. 5 is a block diagram of an exemplary MPEG-2 decoder system in accordance with an embodiment of the present invention; and

FIG. 6 is a block diagram describing the decode and display of frames in accordance with an embodiment of the present invention.

### DETAILED DESCRIPTION OF THE INVENTION

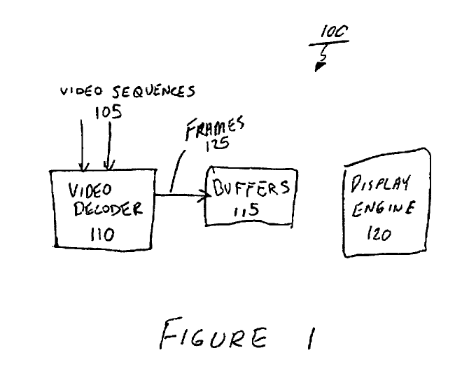

Referring now to FIG. 1, there is illustrated a block diagram describing a decoder 100 for displaying two video sequences 105 in accordance with an embodiment of the present invention. The decoder 100 comprises a video decoder 110, a set of buffers 115, and a display engine 120.

Each video sequence 105 comprises a video stream that is encoded in accordance with a predetermined format. The video stream comprises a plurality of frames forming a video. The predetermined format can include, for example, MPEG-2, or MPEG-AVC. The video decoder 110 decodes the video sequence 105 generating the frames 125 that form the video stream. During each frame display period, the video decoder 110 decodes one frame 125 from each video sequence 105.

The display engine 120 presents one decoded frame 125 from each video sequence 105 for display on a display device. The display engine 120 scales the frames 125 to fit the display screen, and renders the graphics therein. The frames 125 are displayed by the display device in a scanning order. A progressive display device displays the frame from top to bottom and left to right. On an interlaced display device, the even-numbered lines from top to bottom and left to right are displayed, followed by the odd-numbered lines from top to bottom and left to right. In either cases, there are portions of the frame 125 that are displayed prior to other portions of the frame 125. The display engine 120 provides each frame 125 in the scanning order to the display device.

The video decoder 110 has the processing power to decode the frames 125, significantly faster than the display device requires to display the frame. Therefore, the frames 125 are buffered 115 to await scanning by the display engine 120. It is often desirable to reduce the amount of buffer 115 memory, thereby reducing the cost of the decoder system 100. It is also often desirable that the decoder system 100 decode and provide both video sequences 105 for presentation in real-time. To reduce the amount of buffer 115 memory, the decoder system 100 uses flow control to gradually overwrite the displayed frame with the decoded frame. To decode and provide both video sequences 105 for presentation in real-time, the decoder system 100 decodes portions of a frame 125 from each video sequence 105 during each frame display period.

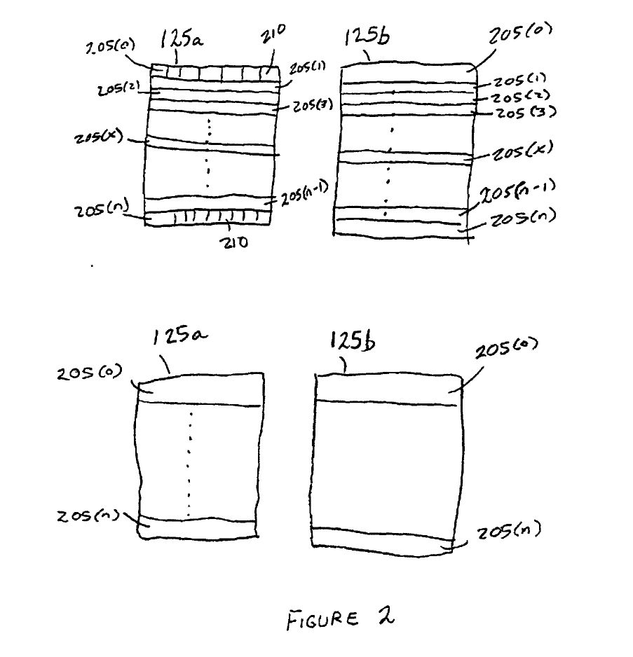

Referring now to FIG. 2, there is illustrated a block diagram of display frames 125a and decode frames 125b, displayed and decoded in accordance with an embodiment of the present invention. Each frame 125 includes numerous horizontal lines 205(0) . . . 205(n) of pixels 210. The decoder system 100 uses flow control to reduce the size of the buffer 110 memory.

The display frames 125a are the frames that are presented for display by the display engine 120 during a frame display period. As noted above, the display engine 120 presents the display frames 125a for display in a raster order. The raster order is either a progressive display order or an interlaced display order. In the progressive order, the display frames 125a are displayed from top to bottom, e.g., 205(0) . . . 205(n). In the interlaced display order, the even numbered lines are displayed from top to bottom, e.g., 205(0), 205(2), . . . 205(n-1), followed by the odd numbered lines from top to bottom, e.g., 205(1), 205(3), . . . 205(n).

With two display frames 125a provided to the display engine 120 during a frame display period, the display engine 120 typically provides a particular line from one decode frame 125a, followed by the same numbered line of the other decode frame 125a.

The decode frames 125b are the frames that the video decoder 110 decodes during the particular frame display period. To reduce the buffer 115 size, as a portion of one display frame 125a is displayed, the video decoder 110 decodes the portion of the decode frame 125b from the same video sequence 105 and overwrites the displayed portion. In the case of progressive display frames, the portion contains contiguous lines 205(0) . . . 205(x), whereas in the case of interlaced frames, the portion contains alternating lines, 205(0), 205(2) . . . 205(2x). After the portion 205(0) . . . 205(x) of the decode frame 125b is decoded, the video decoder 110 waits until the display engine 120 presents the same portion of the display frame 105a from the other video sequence 105. When the display engine 120 displays the portion, the video decoder 110 decodes the portion of the decode frame 125b from the same video sequence 105 and overwrites the displayed portion.

After the video decoder 110 decodes a portion of the decode frame 125b of the other video sequence 105, the video decoder 110 waits for the next portion [205(x+1) . . . 205(2x) for progressive frames, 205(2x+2), 205(2x+4), . . . 205(4x) for interlaced frames] of the display frame 125a to be displayed and repeats the process.

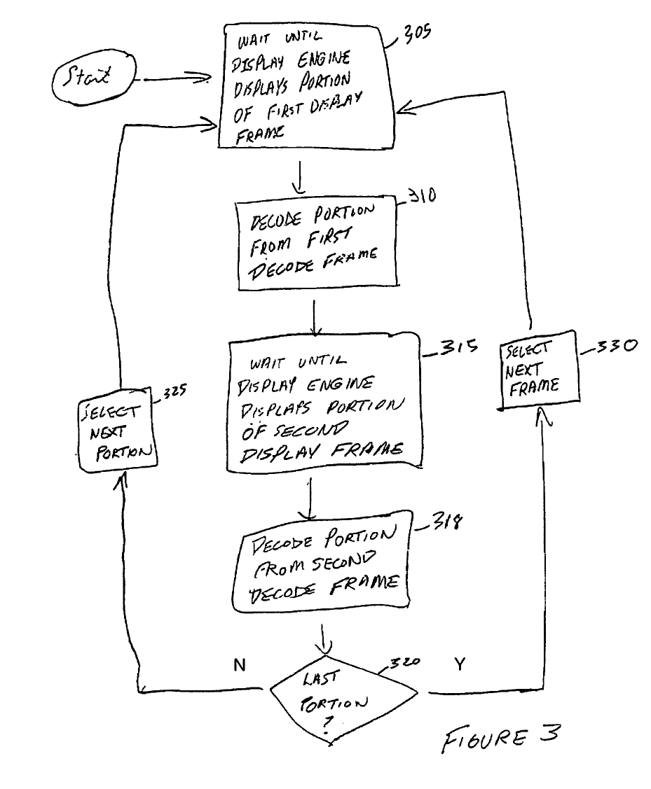

Referring now to FIG. 3, there is illustrated a flow diagram for decoding frames 125 from two video sequences 105 in accordance with an embodiment of the present invention. At 305, the video decoder 110 waits until the display engine 120 displays a portion of a first display frame from a first video sequence. At 310, after the display engine 120 displays the portion of a first display frame from a first video sequence 105, the video decoder 110 decodes a portion of a first decode frame from a first video sequence 105 and overwrites the displayed portion.

At 315, the video decoder 110 waits until the display engine 120 displays a portion of a second frame from a second video sequence 105. After the display engine 120 displays the portion of the second display frame, the decoder 110 decodes (318) a portion of the second decode frame 125 and overwrites the displayed portion.

At 320, the video decoder 110 determines whether the portion decoded during 310 and 320 was the last portion, i.e., included the last line 205(n). If the portion decoded during 310 and 320 was not the last portion, the next portion is selected during 325 and 305 is repeated. If the portion decoded during 310 and 320 was the last portion, the first portion, i.e., a portion including the first line 205(0), of the next frame in the decode order is selected (330) by the decoder 110 and 305 is repeated.

As can be seen, the decoder system 100 provides a plurality of video streams for display while reducing the buffer 115 memory. The decoder system can decode video sequences encoded in accordance with the MPEG-2 standard, MPEG-AVC or other standard.

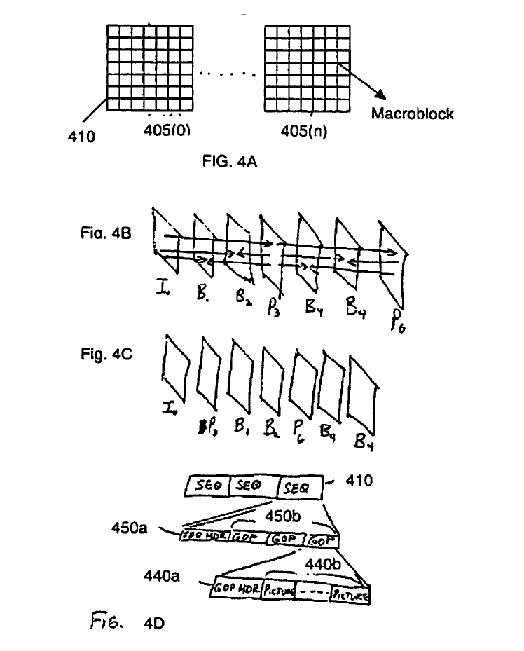

Referring now to FIG. 4A, there is illustrated a block diagram of video data encoded in accordance with the MPEG-2 standard. The video data comprises a series of frames 405. The frames 405 comprise any number of lines 410 of pixels, wherein each pixel stores a color value.

Pursuant to MPEG-2, the frames 405(1) . . . 405(n) are encoded using algorithms taking advantage of both spatial redundancy and/or temporal redundancy. Temporal encoding takes advantage of redundancies between successive frames. A frame can be represented by an offset or a difference frame and/or a displacement with respect to another frame. The encoded frames are known as pictures. Pursuant to MPEG-2, each frame 405(1) . . . 405(n) is divided into 16×16 pixel sections, wherein each pixel section is represented by a macroblock 408. A picture comprises the macroblocks 408 representing the 16×16 pixel sections forming the frame 405.

Referring now to FIG. 4B, there is illustrated an exemplary block diagram of pictures I₀, B₁, B₂, P₃, B₄, B₅, and P₆. The data dependence of each picture is illustrated by the arrows. For example, picture B₂ is dependent on reference pictures I₀, and P₃. Pictures coded using temporal redundancy with respect to either exclusively earlier or later pictures of the video sequence are known as predicted pictures (or P-pictures), for example picture P₃. Pictures coded using temporal redundancy with respect to earlier and later pictures of the video sequence are known as bi-directional pictures (or B-pictures), for example, pictures B₁, B₂. Pictures not coded using temporal redundancy are known as I-pictures, for example I₀. In MPEG-2, I and P-pictures are reference pictures.

The foregoing data dependency among the pictures requires decoding of certain pictures prior to others. Additionally, the use of later pictures as reference pictures for previous pictures, requires that the later picture is decoded prior to the previous picture. As a result, the pictures cannot be decoded in temporal order. Accordingly, the pictures are transmitted in data dependent order. Referring now to FIG. 4C, there is illustrated a block diagram of the pictures in data dependent order.

The pictures are further divided into groups known as groups of pictures (GOP). Referring now to FIG. 4D, there is illustrated a block diagram of the MPEG hierarchy. The pictures of a GOP are encoded together in a data structure comprising a picture parameter set, which indicates the beginning of a GOP, 440a and a GOP Payload 440b. The GOP Payload 440b stores each of the pictures in the GOP in data dependent order. GOPs are further grouped together to form a video sequence 450. The video data 400 is represented by the video sequence 450.

The video sequence 450 can be transmitted to a receiver for decoding and presentation. The data compression achieved allows for transport of the video sequence 450 over conventional communication channels such as cable, satellite, or the internet. Transmission of the video sequence 450 involves packetization and multiplexing layers, resulting in a transport stream, for transport over the communication channel.

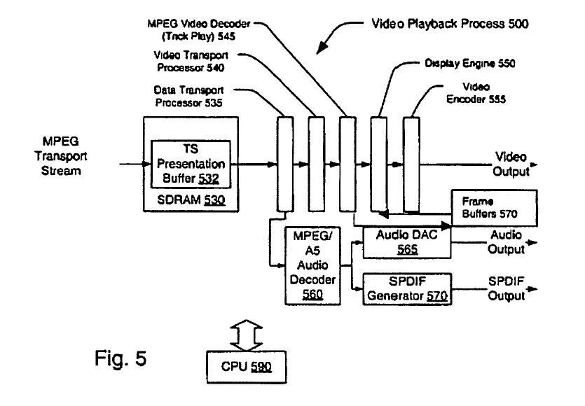

Referring now to FIG. 5, there is illustrated a block diagram of an decoder system 500, in accordance with an embodiment of the present invention. At least two video sequences 450 are received and stored in a presentation buffer 532 within SDRAM 530. The data can be received from either a communication channel or from a local memory, such as a hard disc or a DVD.

The data output from the presentation buffer 532 is then passed to a data transport processor 535. The data transport processor 535 demultiplexes the transport stream into packetized elementary stream constituents, and passes the audio transport stream to an audio decoder 560 and the video transport stream to a video transport decoder 540 and then to a MPEG video decoder 545. The audio data is then sent to the output blocks, and the video is sent to a display engine 550.

The display engine 550 scales the video picture, renders the graphics, and constructs the complete display. Once the display is ready to be presented, it is passed to a video encoder 555 where it is converted to analog video using an internal digital to analog converter (DAC). Additionally, the display engine 550 is operable to transmit a signal to the video decoder 545 indicating that certain portions of the displayed frames have been presented for display. The digital audio is converted to analog in an audio digital to analog (DAC) 565.

The decoder 545 decodes at least one picture, I₀, B₁, B₂, P₃, B₄, B₅, P₆, . . . , from each video sequence 450 during each frame display period. Due to the presence of the B-pictures, B₁, B₂, the decoder 545 decodes the pictures, I₀, B₁, B₂, P₃, B₄, B₅, P₆, . . . , in an order that is different from the display order. The decoder 545 decodes each of the reference pictures, e.g., I₀, P₃, prior to each picture that is predicted from the reference picture. For example, the decoder 545 decodes I₀, B₁, B₂, P₃, in the order, I₀, P₃, B₁, and B₂. After decoding I₀ and P₃, the decoder 545 applies the offsets and displacements stored in B₁ and B₂, to decoded I₀ and P₃, to decode B₁ and B₂. In order to apply the offset contained in B₁ and B₂, to decoded I₀ and P₃, the decoder 545 stores decoded I₀ and P₃ in memory known as frame buffers 570.

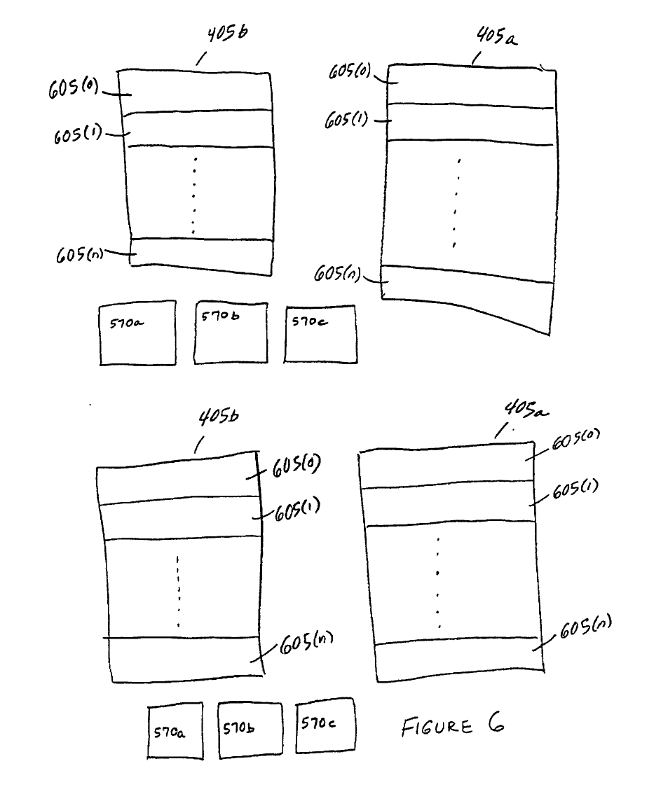

Referring now to FIG. 6, there is illustrated a block diagram of display frames 405a and decode frames 405b, displayed and decoded in accordance with an embodiment of the present invention. The frame buffers 570 includes two prediction frame buffers 570a, 570b, and a B-frame buffer 570c for each video sequence 450. The prediction frame buffers 570a, 570b store decoded I-pictures, and P-pictures. The B-frame buffer 570c stores decoded B-pictures.

When the decode frame 405b is from an I-picture or P-picture, the decoder 545 decodes and stores the decode frame in one of the prediction frame buffers, e.g., 570a, while the display engine 550 reads the display frame 405a stored in either the other prediction frame buffer 570b, or the B-frame buffer 570c.

When the decode frame 405b is a B-picture, one of the prediction buffers 570a stores the past prediction pictures, while the other prediction buffer 570b stores the future prediction picture, or vice versa. The video decoder 545 decodes the B-picture by applying offsets and displacements contained in the B-picture data to the frames in the prediction frame buffers 570a, 570b and writes the decoded B-picture into the B-frame buffer 570c. If the display frame 405a is either a decoded P-picture, or an I-picture, the display engine 550 reads the appropriate prediction frame buffer 570a, 570b. No resource contention occurs.

However, when both the display frame 405a and the decode frame 405b of any video sequence 450 are B-pictures, flow control is used to avoid a resource contention. Each frame 405 is represented by any number of rows 605(0) . . . 605(n) of macroblocks 408. To display the display frame 405a and store the decode frame 405b in the same B-frame buffer 570c, as a portion of one display frame 405a is displayed, the video decoder 545 decodes the portion of the decode frame 405b from the same video sequence 105 and overwrites the displayed portion. The portion can contain one or more macroblock rows 605. After the decoder 545 decodes the portion, e.g., comprising macroblock row 605(0), of the decode frame 405b, the video decoder 545 waits until the display engine 550 presents the next portion, macroblock row 605(1), of the display frame 405a for display. After the portion, macroblock row 605(1) of the display frame 405a is displayed, the video decoder 545 decodes and overwrites the portion, macroblock row 605(1), of the display frame 405a, with the portion, macroblock row 605(1) from the decode frame 405b. The foregoing continues for each of the macroblock rows 605(1) . . . 605(n) of the decode frame 405b and the display frame 405a.

When both the display frames 405a and decode frames 405b of both video sequences 450 are B-pictures, the video decoder 545 uses flow control to decode and display the frames in real-time without resource contention. The video decoder 545 waits until the display engine 550 displays a macroblock row 605(0) of a first display frame 405a from a first video sequence 450 to decode macroblock row 605(0) of the first decode frame 405b from the first video sequence 450 and overwrites the displayed macroblock row 605(0) of the displayed frame 405a.

The video decoder 545 then waits until the display engine 550 displays macroblock row 605(0) of the second display frame 405a from the second video sequence 450 to decode macroblock 605(0) of the decode frame 405b of the second video sequence 450, and overwrites the macroblock row 605(0) of the display frame 405a.

Then the video decoder 545 waits until the display engine 550 displays macroblock row 605(1) of the first display frame 405a from a first video sequence 450 and repeats the same for each macroblock row 605 of the decode 405b and display frames 405a.

The synchronization between the video decoder 545 and the display engine 550 can be achieved by transmission of signals from the display engine 550 indicating that portions of a particular frame from a particular video sequence have been presented for display. The video decoder 545 can receive the signals as interrupts. After receiving the interrupt, an interrupt handler can cause the video decoder 545 to decode the next portion of the frame. Additionally, the interrupt subroutine can include a ping-pong indicator (a scheduler) that swaps the video sequences at each interrupt, causing the video decoder 545 to decode the correct video sequence.

One embodiment of the present invention may be implemented as a board level product, as a single chip, application specific integrated circuit (ASIC), or with varying levels integrated on a single chip with other portions of the system as separate components. The degree of integration of the monitoring system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor can be implemented as part of an ASIC device with various functions implemented as firmware.

While the invention has been described with reference to certain embodiments, it will be understood by those skilled in the art that various changes may be made and equivalents may be substituted without departing from the scope of the invention. In addition, many modifications may be made to adapt particular situation or material to the teachings of the invention without departing from its scope. Therefore, it is intended that the invention not be limited to the particular embodiment(s) disclosed, but that the invention will include all embodiments falling within the scope of the appended claims.

1. A method for decoding a plurality of frames, said method comprising:
decoding a first portion of a first frame;
decoding a first portion of a second frame after decoding the first portion of a first frame; and
decoding a second portion of the first frame after decoding the first portion of the second frame.

2. The method of claim 1, wherein the first portion of the first frame is associated with a row of macroblocks.

3. The method of claim 1, wherein the first frame is associated with a first video sequence, and wherein the second frame is associated with a second video sequence.

4. The method of claim 1, further comprising:
displaying the first frame and the second frame during the same frame display period.

5. The method of claim 1, further comprising:
displaying a first portion of a third frame before decoding the first portion of the first frame; and
displaying a second portion of the third frame after decoding the first portion of the first frame.

6. The method of claim 5, further comprising:
receiving a first interrupt, said interrupt indicating that the first portion of the third frame has been displayed; and
wherein decoding the first portion of the first frame is responsive to receiving the interrupt.

7. A circuit for displaying a plurality of frames, said circuit comprising:
a decoder for decoding a first portion of a first frame, a first portion of a second frame after decoding the first portion of the first frame, and decoding a second portion of the first frame after decoding the first portion of the second frame;
a first frame buffer for storing the first and second portion of the first frame; and
a second frame buffer for storing the first portion of the second frame.

8. The circuit of claim 7, wherein the first portion of the first frame comprises a macroblock row.

9. The circuit of claim 7, wherein the first frame is associated with a first video sequence, and wherein the second frame is associated with a second video sequence.

10. The circuit of claim 7, further comprising:
a display engine for displaying the first frame and the second frame during the same frame display period.

11. The circuit of claim 7, wherein the display engine displays a first portion of a third frame before the decoder decodes the first portion of the first frame and displays a second portion of the third frame while the decoder decodes the first portion of the first frame.

12. The circuit of claim 11, wherein the display engine transmits an interrupt to the decoder, said interrupt indicating that the first portion of the third frame has been displayed and wherein the decoder can decode the first portion of the first frame responsive to receiving the interrupt.

13. A circuit for decoding frames, said circuit comprising:
a controller; and
a memory connected to the controller, storing a plurality of instructions executable by the controller, wherein the instructions comprise:
decoding a first portion of a first frame;
decoding a first portion of a second frame after decoding the first portion of a first frame; and
decoding a second portion of the first frame after decoding the first portion of the second frame.

14. The circuit of claim 13, wherein the first portion of the first frame is associated with a row of macroblocks.

15. The circuit of claim 13, wherein the first frame is associated with a first video sequence, and wherein the second frame is associated with a second sequence.

16. The circuit of claim 13, wherein the instructions further comprise:
displaying the first frame and the second frame during the same frame display period.

17. The circuit of claim 13, wherein the instructions further comprise:
displaying a first portion of a third frame before decoding the first portion of the first frame; and
displaying a second portion of the third frame while decoding the first portion of the first frame.
